(19) United States
(12) Patent Application Publication
(10) Pub. No.: US 2007/0233741 A1
(43) Pub. Date: Oct. 4, 2007

(54) Interface for seamless integration of a non-linear editing system and a data archive system

(75) Inventors: Sudy Shen, Richmond Hill (CA); Cristian Saceanu, Thornhill (CA)

Correspondence Address: OPPENHEIMER WOLFF & DONNELLY LLP, 45 SOUTH SEVENTH STREET, SUITE 3300, MINNEAPOLIS, MN, 55402, US

(73) Assignee: Masstech Group Inc., Richmond Hill (CA)

(21) Appl. No.: 11/732,004

(22) Filed: Apr. 2, 2007

Related U.S. Application Data
(60) Provisional application No. 60/787,892, filed on Mar. 31, 2006.

(51) Int. Cl. G06F 17/00

(52) U.S. Cl. 707/104.1

(57) ABSTRACT

To provide consistent operation within an A/V handling system, a coordinated interface is provided to allow the transfer of data between an editing system, capable of editing video signals, and a data archive system, designed for archival purposes. The interface of the present invention takes into account the different data types native to the editing and archival applications, and provides accommodations for transcoding of data types as necessary. Further, the interface is uniquely configured to allow either system to initiate data transfers and the related transcoding operations.

### BACKGROUND OF THE INVENTION

This application claims the benefit of Provisional Application No. 60/787,892 filed Mar. 31, 2006.

The present invention relates to a component interface within an audio/video processing system. More specifically, the invention is a method and process for providing an interface from an audio/video non-linear editing system to an external data archive system which allows the transfer of audio/video data between the two systems. The external data archive system is capable of actively transcoding the audio/video data from a plurality of editable formats native to the non-linear editing system to one of a plurality of video server or data archive formats. The inventive system interface allows a user on either the non-linear editing system or the data archive system to initiate a data transfer.

Systems for the management and use of audio/visual signals typically involve many different subsystems and components, each necessary for carrying out a particular task. Unfortunately, each of the various systems are typically more efficient when a particular file format is utilized. Consequently, the coordination of various systems with one another is further complicated by these different file types. As an example, data archieve and data storage applications typically utilize a preferred format to accommodate the needs of those applications. Likewise, a second data format is often more effective for editing of audio/visual data, including various data types that may be unique to the editor itself. Further, a third data format may be more conducive for broadcast transmission purposes. Based upon these format differences, it is challenging for the various subsystems to deal with data provided in various formats. Thus interfacing between any of these subsystems is more complicated than simply providing straight forward data transfers.

In addition to the different formats involved, audio/visual information typically includes tremendous amounts of data. Broadcast quality audio/visual signals are made up of very complex data structures, thus their processing and management is further complicated by the sheer size of data files involved. The tasks of processing the data typically requires considerable resources, and can become very involved. Thus, it is often desirable to encode data files whenever possible.

### BRIEF SUMMARY OF THE INVENTION

To accommodate the interaction between a various subsystems within a audio/visual data management system, the present invention provides an interface to effectively allow data transfer. More specifically, to allow interaction between a non-linear editing system, and a data archive system, the present invention provides interface accommodations which addresses the different data formats encountered. To achieve this interface, components within an audio-visual editing suite, and a data storage system are provided which recognize the differences in data formats typically utilized, and provides the ability and communication tools to efficiently provide an interface between those two components.

Within the non-linear suite, utilized by the present invention, a transfer manager is included. Traditionally, this transfer manager is capable of managing transfers of audio/visual files to a video server, from internal storage. The transfer manager of the present invention, however, coordinates with a transfer server within a data archiving system. The data archiving system can then help to coordinate transfer of data to the video server as needed.

To achieve the above coordination and management of data transfers, the data archiving system includes the transfer server, along with a transcoding engine. The transcoding engine provides the archive system with the capability to transcode audio/visual data between the various formats that may be most appropriate for archiving and/or editing.

The present invention further includes processes for the transfer and manipulation of data which can be initiated by either a video editor, or a data archive system. Within these processes, the editor's transfer manager, and the data archive system's transfer server, both coordinate with one another to achieve the necessary transfers. Further, the transcoding engine of the data archive system is called upon to perform whatever conversions are necessary. Once the appropriate adjustments or conversions are made, signals can then be sent to the component making the request, in a most desirable format.

### BRIEF DESCRIPTION OF THE DRAWINGS

Further objects and advantages of the present invention can be seen from reading the following detailed description, in conjunction with the drawings in which;

FIG. 1 is a block diagram illustrating a traditional non-linear editing suite;

FIG. 2 is a block diagram illustrating the interface of the present invention between the non-linear editing suite and data archive system;

FIG. 3 is a flow chart illustrating the steps taken when the editing system wishes to retrieve information; and

FIG. 4 is a flow chart which illustrates the steps taken when the data archive system requests information from the editing system.

### DETAILED DESCRIPTION OF THE INVENTION

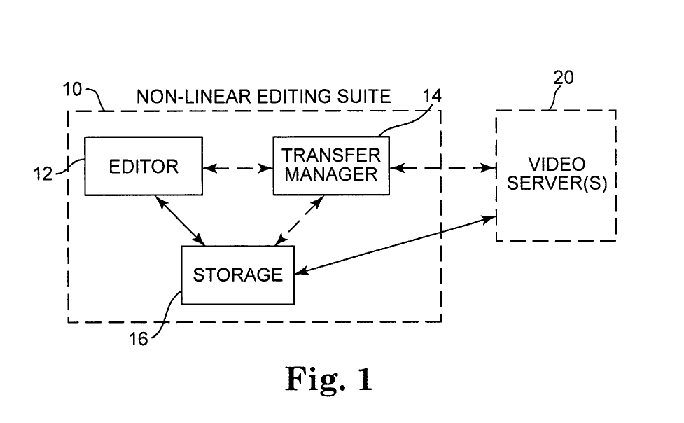

Referring now to FIG. 1, the major components of an audio/video Non-Linear Editing (NLE) suite 10 are illustrated schematically. The editing suite is composed of an audio/video editor 12, a transfer manager 14 and system storage 16. Transfer manager 14 controls the transfer of audio/video data from the editor to system storage and from system storage to external video servers(s) 16. Transfer manager 14 is an existing component of an NLE system and includes software processes and protocols which govern the exporting and importing of audio/video data into and out of external storage locations such as video server(s) 20.

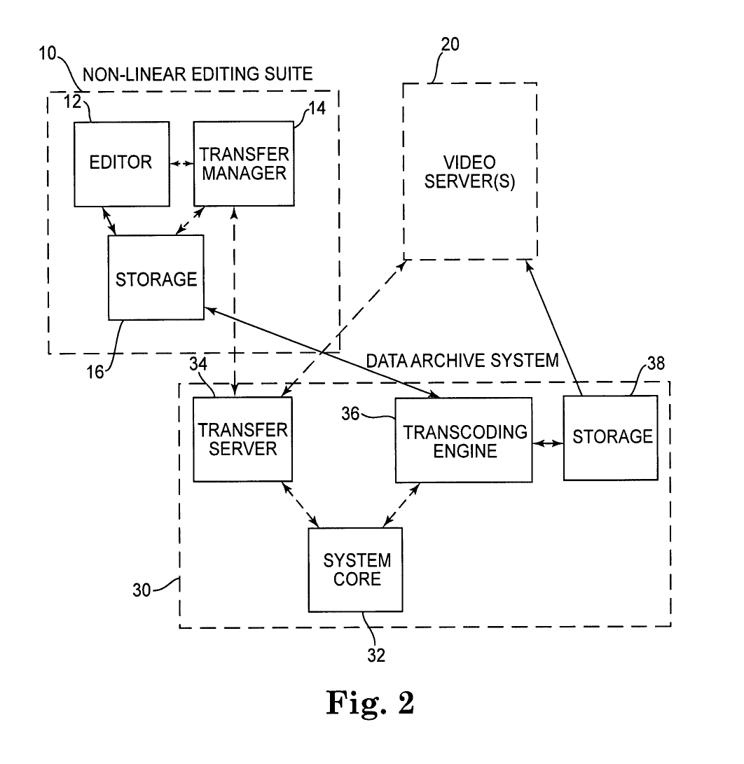

FIG. 2 is a block diagram illustrating the integration of the NLE suite with an external Data Archive System 30 (DAS) which allows the passing of audio/video data from the NLE suite to the DAS for storage and subsequent retrieval. DAS 30 contains a system core 32, a transfer server 34, a transcoding engine 36 and storage 38. The NLE transfer manager 14 communicates with DAS transfer server 34 to initiate the data transfer process. Transfer server 34 in turn communicates with DAS system core 32 and obtains access to transcoding engine 36 for receiving and processing data received from NLE storage 14. The audio/video data generated and stored within the NLE suite is typically stored in an editing format which may not be compatible with video server formats or data archive formats. Transcoding engine 36 transcodes editable format to playout format and vice-versa as needed.

In a preferred embodiment the inventive method of integrating an NLE with a DAS is used to integrate an Avid editing suite sold by Avid Technology Inc. with a MassStore data archive system manufactured and sold by the applicant. The Avid editing suite includes a specification for importing and exporting data called Avid Dynamic Handle Module (DHM) which defines the specification for ingesting data into Avid (copy-out from the point of view of MassStore) and for playback (copy-in from the point of view of MassStore). Avid DHM specifies protocols and Dynamic Link Libraries (DLL) that must be implemented by third party applications to integrate their operation with the Avid editing suite.

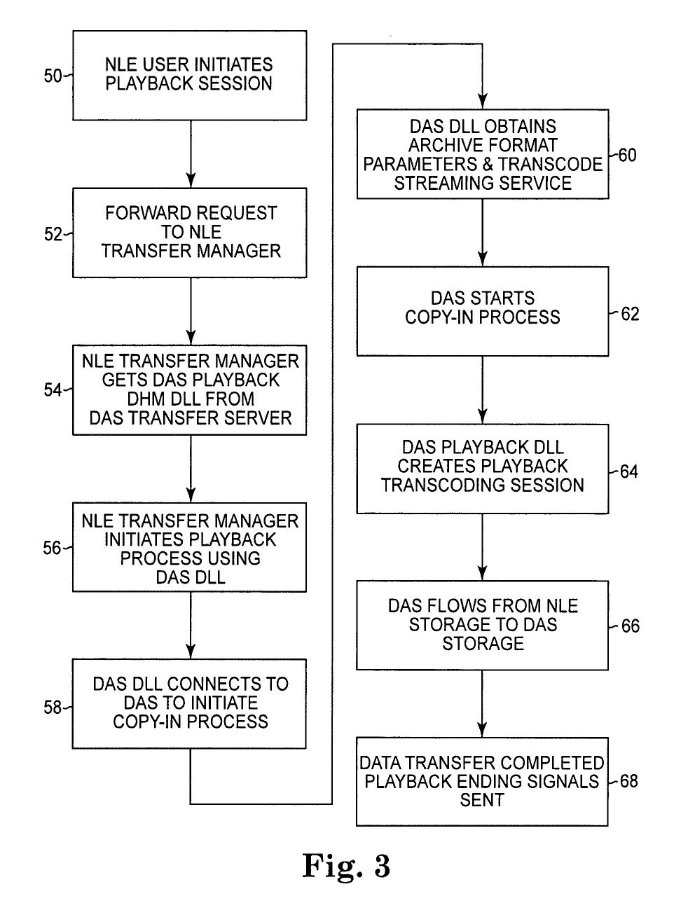

FIG. 3 is a flowchart which illustrates the sequence of steps that are followed by the inventive interface when a user of an Avid editing system wishes to playback audio/video content from Avid to a MassStore data archive. The process starts when at step 50 when an NLE user initiates a playback session. In the next step 52, the request for playback is forwarded to NLE Transfer Manager 16 which then communicates with DAS Transfer Server 34 to get the DAS Playback DHM DLL in step 54. The NLE Transfer Manager then initiates the playback process using the DAS Playback DHM DLL in step 56. In the preferred embodiment, the first four steps 50-56 described above are native to the Avid system while the remaining steps described below are native to the MassStore system. Step 56 is followed by step 58 in which the DAS DLL connects to the DAS to initiate the copy-in process. In step 60 the DAS DLL obtains archive format parameters and gains access to a Transcode Streaming Service hosted by the Transcode Engine module 36 of the DAS. The Transcode Streaming Service converts the format of the data from an editing format to a playout format and vice versa as needed. In step 62 the DAS starts the copy-in process and in step 64 the DAS playback DLL creates a playback transcoding session thereby readying both systems for the flow of data from the NLE to the DAS (step 66). Finally when the data transfer is complete, signals are sent to the NLE Transfer Manager and the DAS Transfer Server to end the playback session in step 68.

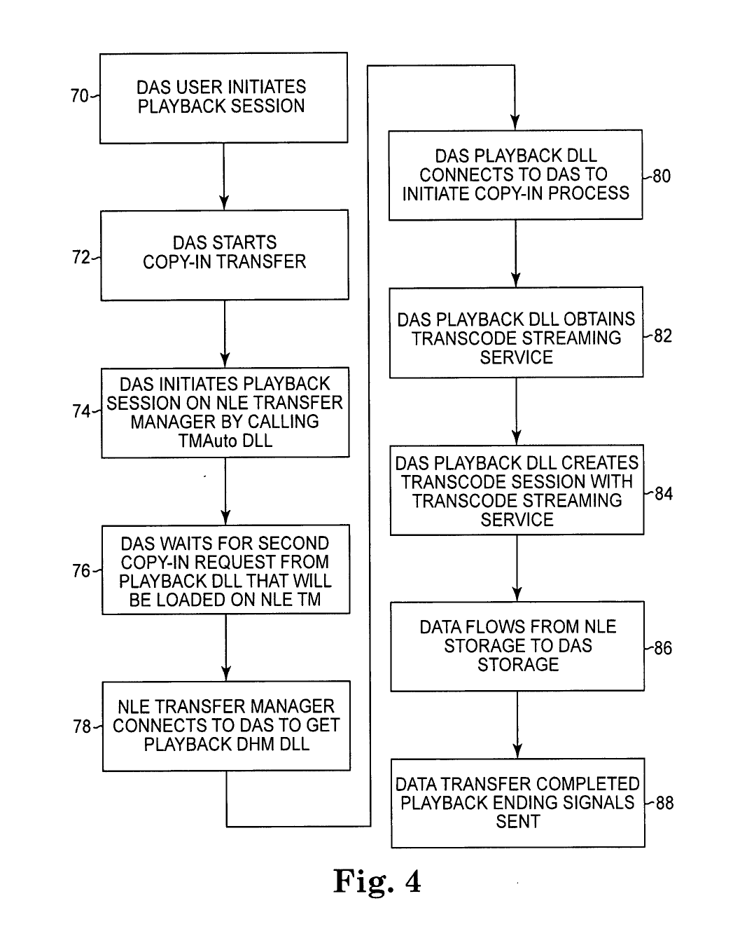

FIG. 4 is a flowchart similar to FIG. 3 which shows the sequence of steps that are followed when a user of the MassStore data archive initiates a playback of audio/video content from Avid to a MassStore storage device. The process starts with a DAS user initiating a playback session at step 70 followed by step 72 where the DAS starts the copy-in (Avid playback) process. In the next step 74 the DAS initiates a playback session in the NLE Transfer Manager by calling the Transfer Manager Automation (TMAuto) DLL which allows the DAS to remotely control the NLE Transfer Manager. Once the NLE Transfer Manager is activated, the DAS waits for a second copy-in request from the NLE Transfer Manager in step 76, followed by a transfer of the DAS playback DHM DLL to NLE Transfer Manager in step 78. Similarly to process described in FIG. 3, the initial steps 70-78 described above are native to the Avid system while the remaining steps described below are implemented on the MassStore system. In step 80 the DAS playback DLL connects to the DAS to initiate the copy-in process followed by the DAS playback DLL obtaining a transcode streaming service from Transcoding Engine 36 in step 82. The DAS playback DLL creates a transcoding session in step 84 which leads to the flow of data in step 86 from the NLE to DAS storage. Finally in step 88 signals are sent ending the playback session when the data transfer is complete.

The inventive interface allows users on both a non-linear editing system and a data archive system to initiate the transfer of data from one system to the other and the automatic transcoding of data provides seamless data transfer regardless of the format the data is stored in. A further advantage of the inventive interface is that it allows NLE users to store audio/video content indefinitely on data archive storage devices such as disk cache or tape libraries which are typically less expensive that NLE or video server storage. From data archive storage the NLE produced content can be converted or transcoded to a playback server or other environment on demand. Yet another advantage of the inventive interface is that it allows NLE users to easily playback and view content using data archive hardware which is less expensive than video servers.

What is claimed is:

1. A coordinated system for editing and archival video data systems including cooperation with a video server, the system comprising:
a non-linear a/v data editing system having an editor, editing system memory, and an transfer manager, the editor capable of directly accessing the editing system memory to provide editing capabilities, the editor further coupled to the transfer manager to assist in the transfer of necessary data, and
a data archive system for the managed archive and storage of a/v data and the direct communication of a/v data to the video server, the data archive system having a transfer server, a system core, a transcoding engine and archive storage, wherein the transfer server is coupled to the transfer manager in the data editing system to coordinate the necessary transfer of information, the transfer server further coupled to the system core and the video server to provide further coordination therebetween, the system core further coupled to the transcoding engine to provide overall instruction related to the archive system operation, the transcoding engine further directly coupled to the editing system memory and the archive system storage to allow direct data transfer between, with the data archive system storage also being directly coupled to the video server, wherein the transfer manager and the transfer server are each capable of initiating a data transfer between the data archive system and the editing system.

2. The system of claim 1 wherein all data passed to the video server is provided by the archive system storage.

3. The system of claim 1 wherein the transcoding engine is capable of transcoding data between an editing format utilized the editing system, and an archive format utilized by the archive system.

4. The system of claim 3 wherein the transcoding engine is further capable of transcoding to a playout format utilized by the video server.

5. The system of claim 3 wherein the data archive format is also usable by the video server for playout.

6. The system of claim 1 whereby data is passed through the transcoding engine in each case to insure requested data is converted to the desired data format.
